(19) United States
(12) Patent Application Publication
(10) Pub. No.: US 2014/0355520 A1
(43) Pub. Date: Dec. 4, 2014

(54) SYSTEM AND METHOD FOR VISITING SUBSCRIBER SERVER IN IMS CORE NETWORKS

(71) Applicant: Mavenir Systems, Inc., Richardson, TX (US)

(72) Inventor: Michael Brett Wallis, McKinney, TX (US)

(73) Assignee: Mavenir Systems, Inc., Richardson, TX (US)

(21) Appl. No.: 14/270,504

(22) Filed: May 6, 2014

Related U.S. Application Data
(60) Provisional application No. 61/829,843, filed on May 31, 2013.

(51) Int. Cl. H04W 8/04; H04W 8/18; H04W 12/06

(52) U.S. Cl. CPC H04W 8/04; H04W 12/06; H04W 8/18
USPC 370/328

(57) ABSTRACT

A method for supporting an inbound roaming subscriber in an IMS network, comprises receiving a request from the inbound roaming subscriber to access the IMS network, determining the inbound roaming subscriber's home network, retrieving authentication credentials from the inbound roaming subscriber's home network, and verifying the authentication credentials, dynamically deriving public and private user identities for the inbound roaming subscriber, and creating and storing a subscriber record for the inbound roaming subscriber.

### RELATED APPLICATION

The present application claims the benefit of U.S. Provisional Patent Application Ser. No. 61/829,843 filed on May 31, 2013.

### FIELD

The present disclosure relates to a system and method for system and method for visiting subscriber server (VSS) in IMS (IP Multimedia Subsystem) core networks.

### BACKGROUND

The Third Generation Partnership Project (3GPP) unites six telecommunications standards bodies, known as “Organizational Partners,” and provides their members with a stable environment to produce the highly successful Reports and Specifications that define 3GPP technologies. A mobile device, also called a User Equipment (UE), may operate in a wireless communication network that provides high-speed data and/or voice communications. The wireless communication networks may implement circuit-switched (CS) and/or packet-switched (PS) communication protocols to provide various services. For example, the UE may operate in accordance with one or more of an Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA: includes Wideband-CDMA (W-CDMA) and Low Chip Rate (LCR) cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long-Term Evolution (LTE) is a new release of UMTS that uses E-UTRA. UTRA, E-UTRA, GSM, UMTS and LTE are described in specification documents from an organization named “3rd Generation Partnership Project” (3GPP). These various radio technologies and standards are known in the art.

The IMS (IP Multimedia Subsystem) as defined by 3GPP is an all-IP architecture for offering multimedia services such as Voice over IP (VoIP). The IMS core network includes the Call Session Control Function (CSCF) and the Home Subscriber Server (HSS). The CSCF facilitates session setup and teardown using SIP (Session Initiation Protocol). HSS plays the role of a location server in IMS and also serves as a repository for subscriber data. CSCF is divided into three logical entities: Proxy CSCF (P-CSCF), Interrogating CSCF (I-CSCF), and Serving CSCF (S-CSCF). P-CSCF is responsible for routing incoming SIP messages to the IMS registrar server and for facilitating policy control. I-CSCF acts as an inbound SIP proxy server in the IMS. S-CSCF is the heart of the IMS core network. It facilitates the routing path for mobile originated or terminated session requests and is the most processing intensive node of the IMS core network.

IMS core networks are defined to support home subscribers only, unlike legacy circuit switched (CS) core networks that support both home subscribers as well as inbound roamers. An inbound roamer is a subscriber with its home defined in an operator X's communication network roaming in or visiting operator Y's communication network, where operator X and operator Y have a roaming agreement to allow this. In such a scenario, operator Y is able to get roaming revenue, as these inbound roamers are charged extra fees to use operator Y's network. These are typically called “roaming charges.”

With LTE (Long-Term Evolution) access and IMS core networks, inbound roamers are supported on radio access. However, only voice over LTE (VoLTE) services are available if the inbound roamer's home network supports an IMS core network and relevant application servers (AS).

### BRIEF DESCRIPTION OF THE DRAWINGS

FIG. 1 is a simplified block diagram of an exemplary network architecture according to the present disclosure;

FIG. 2 is a simplified block diagram of an exemplary system and method for a visiting subscriber server in an IMS core network;

FIG. 3 is a simplified block diagram of another exemplary system and method for a visiting subscriber server in an IMS core network;

FIG. 4 is a simplified flowchart of an exemplary registration method for a visiting subscriber server in an IMS core network;

FIG. 5 is a simplified flowchart of an exemplary mobile originated method for a visiting subscriber server in an IMS core network; and

FIG. 6 is a simplified flowchart of an exemplary mobile terminated method for a visiting subscriber server in an IMS core network.

### DETAILED DESCRIPTION

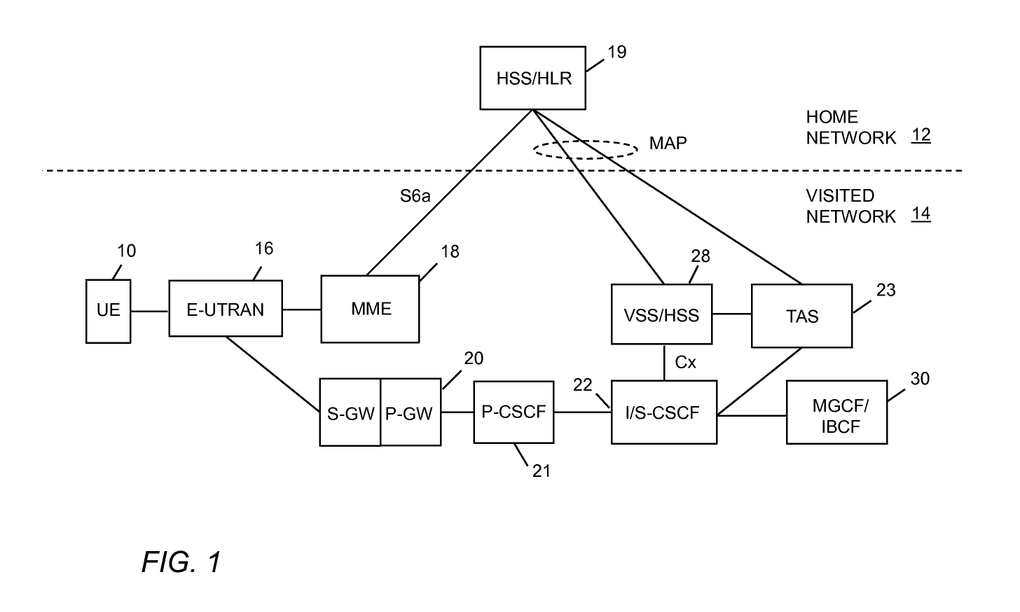

FIG. 1 is a simplified block diagram of an exemplary network architecture according to the present disclosure. A mobile device, referred to as User Equipment (UE) 10, has traveled away from its home network 12, a GSM (Global System for Mobile Communications) core network, and roaming in a visited network 14, which is an IMS (IP Multimedia Subsystem) core network. The two networks 12 and 14 are managed and operated by two independent network operators who have an agreement in place to service each other's subscribers. The UE 10 is connected to the EPC (Evolved Packet Core) over E-UTRAN (Evolved UMTS Terrestrial Radio Access Network) 16. The EPC includes the Mobility Management Entity (MME) 18, which is the key control-node for the LTE access-network. It handles signaling related to mobility and security for E-UTRAN access. The MME 18 is coupled to the Home Subscriber Server (HSS)/Home Location Register (HLR) 19 in the home network 12 via an S6a interface. The HSS/HLR 19 is a central database that contains user-related and subscription-related information. It also provides support functions in mobility management, call and session setup, user authentication and access authorization. The EPC further includes Serving-Gateway (S-GW) and PDN (Packet Data Network) Gateway (P-GW) 20 coupled to the E-UTRAN 16, MME 18. The SGW routes and forwards user data packets, while also acting as the mobility anchor for the user plane during inter-eNodeB handovers and as the anchor for mobility between LTE and other 3GPP technologies. The PDN Gateway provides connectivity from the UE to external packet data networks by being the point of exit and entry of traffic for the UE. A UE may have simultaneous connectivity with more than one PGW for accessing multiple PDNs. The PGW performs policy enforcement, packet filtering for each user, charging support, lawful interception and packet screening.

The EPC is connected to external networks, such as the IP Multimedia Core Network Subsystem (IMS) in the visited network 14. The visited network 14 further includes network functions P-CSCF (Proxy-Call Session Control Function) 21, I-CSCF (Interrogating-Call Session Control Function), and S-CSCF (Serving-Call Session Control Function). I-CSCF and S-CSCF are shown here as a combined network node I/S-CSCF 22 to service inbound roaming subscribers. Those subscribers that are in their home IMS network are serviced by the network operator's I-CSCF and S-CSCF network nodes (not shown). Inbound roaming subscribers are also serviced by Telephony Application Servers (TAS) 23 to provide advanced supplementary and IN (Intelligent Network) services.

Further provisioned is a novel Visiting Subscriber Server (VSS) node or function 28 that is also connected to the HSS/HLR 19 via a MAP interface. As shown in FIG. 1, the VSS functionality 28 may reside within an HSS network node. A MGCF/IBCF (Media Gateway Controller Function/Interconnection Border Control Function) 30 is further coupled to the I/S-CSCF 22 to enable the IMS network to communicate with circuit switched circuits. Operations of the network components are described in more detail below. The VSS is used to support visiting subscribers in the IMS core network.

In an alternate visited network architecture, an IMS Centralized Services Gateway (ICS GW) may be used to connect legacy GSM/UMTS access networks (and thus legacy GSM/UMTS mobile devices) with an IMS core network. The ICS GW may make the UE appear as an IMS UE to the IMS core network. The ICS GW would be coupled to the I/S-CSCF, which is then connected to the VSS. The ICS GW in the visited network terminates the CS access interfaces, and the UE is interworked to the IMS core in the visited network. The VSS is also used in this architecture to support visiting CS subscribers in the IMS core network.

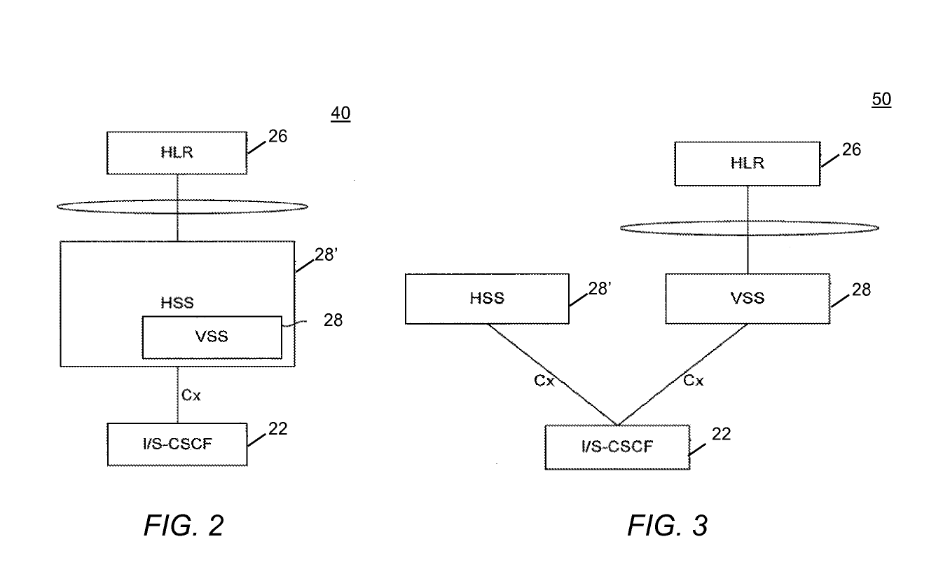

FIG. 2 is a simplified block diagram of an exemplary system and method for a visiting subscriber server functionality 28 in the IMS core network. Shown in FIG. 2 is a system architecture 40 of IMS core network components including the VSS functionality 28 within the HSS 28′. FIG. 2 also depicts a I/S-CSCF 22 which may include a Cx interface to the HSS 28′ and/or the VSS 28. Also, the HSS 28′ communicates with the HLR 180 via a MAP interface.

With reference now to FIG. 3, a block diagram of a system architecture 50 of IMS core network components illustrates yet another embodiment of a VSS. VSS 28 is illustrated as being physically separate from the HSS 28′. FIG. 3 also depicts the I/S-CSCF 22 which includes a Cx interface to the HSS 28′ and the VSS 28. The VSS 28 communicates with the HLR 26 via a MAP interface.

As is known, the HSS functions statically with preconfigured subscriber information and all data necessary to provide access to the IMS such as telephone numbers, authentication criteria, etc. In these exemplary embodiments, the VSS effectively and dynamically creates similar public and/or private records for visiting subscribers. Rather than being pre-populated with the subscriber records maintained by the HSS, embodiments of the VSS function dynamically to create temporary subscriber records corresponding to inbound roaming subscribers to provide access to the IMS core network.

At the time of a subscriber registering with the IMS core network, the user profile is downloaded to the S-CSCF, where the user profile is stored during the registration procedure. A part of this profile is a list of Initial Filter Criteria (iFC). The iFC contain information about application servers (AS) to be involved in the signaling path for sessions and/or standalone requests to furnish services to the user. These AS are involved in SIP message forwarding via the ISC (IP Multimedia Service Control) interface. The conditions for the AS to be invoked (e.g., based on message content) are referred to as the filter rules. Each time value added services need to be executed, iFC processing performed by the S-CSCF enables Applications Servers to be put in the route of the SIP dialog. This means that S-CSCF will forward the SIP message to the first AS (the one with the highest priority) for which iFC trigger point is satisfied. The IMS network includes a plurality of AS nodes to provide advanced services, and one or more TAS nodes or functions are provided to service inbound roaming subscribers.

To authenticate a visiting subscriber to have access to a network such as an LTE network, the VSS obtains authentication credentials in a dynamic manner by obtaining the authentication credentials from a HLR that resides in the visiting subscriber's home network. After authentication, the visiting subscriber is registered with the IMS core of the current or visited network. During the IMS procedures, a temporary subscriber record is created and stored in the VSS. The storage may be performed via memory, database, etc. The VSS may have its own database or it may share a database with other components within the network such as the HSS.

Embodiments of the VSS may preferably store information persistently, i.e., via geographic redundancy, for back-up purposes in case of, for example, catastrophic failure. In other words, the VSS preferably has the same reliability as the HSS with storage and retrieval of subscriber information.

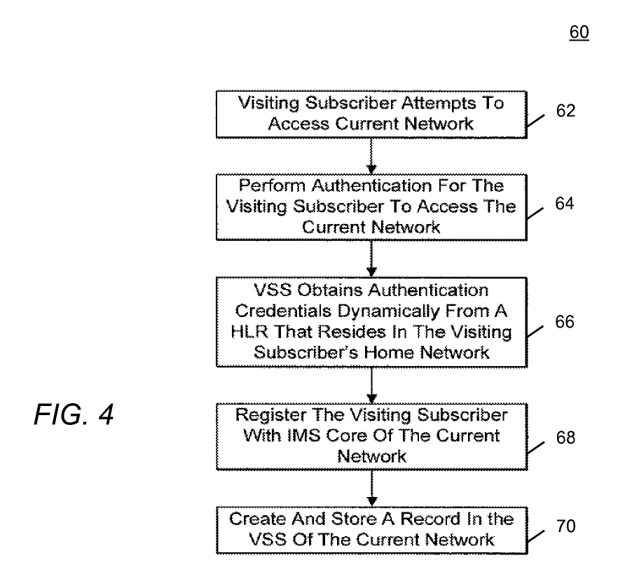

FIG. 4 is a simplified flowchart of an exemplary registration method 60 for a visiting subscriber server in an IMS core network. Referring to FIG. 1 along with references to FIG. 4, the visiting subscriber (UE 10) attempts to access the current network 14, as shown in block 62. The UE may send an attach request that may be a combined EPS/IMSI (Evolved Packet System/ International Mobile Subscriber Identity) attach request to the EPC. After successful attachment, the UE sends a request to access the network that may take the form of a SIP registration message. The SIP registration message may include the user's MSISDN (Mobile Station International Subscriber Directory Number) and/or IMSI (International Mobile Subscriber Identity), for example. The registration request also includes an identification of the subscriber's home network, e.g., the home domain name. The registration request is routed to P-CSCF, which routes the request to the inbound roaming I/S-CSCF 22. Standard Cx protocol is used between I/S-CSCF 22 and VSS 28. Further, the VSS 28 also dynamically derive the IMS public and private user identities for the inbound roaming subscriber using the MSISDN and IMSI.

In block 64, authentication for the visiting subscriber 10 to access the current network 14 is initiated. In block 66, the VSS 28 obtains authentication credentials such as AKA (Authentication and Key Agreement) vectors dynamically from an HLR 26 that resides in the visiting subscriber's home network 12. The VSS 28 may send a MAP Send Authentication Info (SAI) message to the HLR. After successful authentication, registration of the visiting subscriber 10 with the IMS core network is performed in block 68. In block 70, the VSS 28 creates a temporary subscriber record and stores it in the VSS 30 and/or HSS 20 of the current network 14. This may further include providing the subscriber's IMS profile to the I/S-CSCF 22, which may include locally-configured iFCs. The iFC triggers third party IMS registration to TAS. Separate iFC sets may be provisioned for each roaming partner.

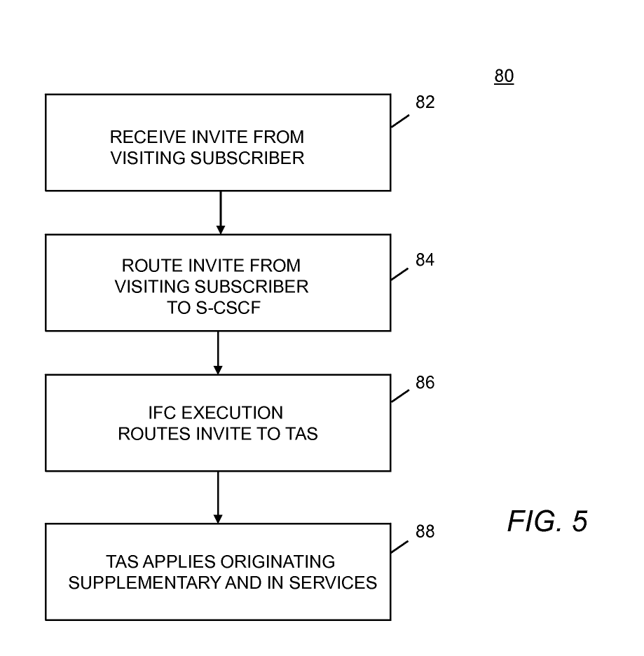

FIG. 5 is a simplified flowchart of an exemplary mobile originated method 80 for a visiting subscriber server in an IMS core network. Generally, standard IMS procedures are followed. In blocks 82 and 84, the UE 10 sends a SIP invite request to the visited P-CSCF with called user identity, which verifies that the public identity in the invite request is currently registered and forwards the request to the inbound roaming I/S-CSCF 22. iFC execution causes the invite message to be routed to AS/TAS, as shown in block 86. In block 88, the TAS then provides originating supplementary and IN (Intelligent Network) services to the UE 10 based on the user profile previously downloaded from the HLR 28.

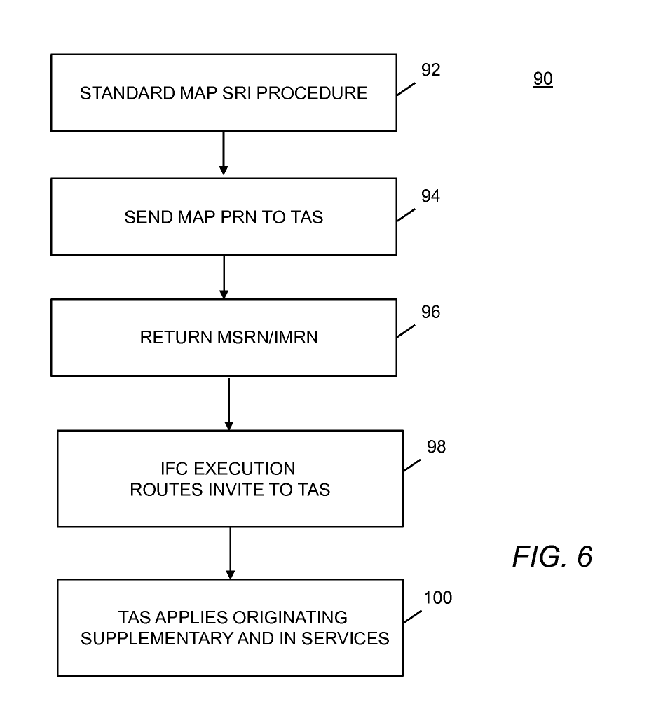

FIG. 6 is a simplified flowchart of an exemplary mobile terminated method 90 for a visiting subscriber server in an IMS core network. In block 92, standard MAP SRI (Send Routing Information) procedures between GMSC (Gateway Mobile Services Switching Center) and HLR in the HPLMN (Home Public Land Mobile Network) are followed for the mobile terminated call. These procedures include the GMSC sending the HLR a MAP SRI message that contains the MSISDN (Mobile Station International Subscriber Directory Number). The HLR then determines the IMSI from the MSISDN. Because of past UE location updates, the HLR knows the location of the UE, or the serving VLR for the UE. In this instance, the serving VLR is the TAS. In block 94, the HLR sends a MAP PRN (Provide Roaming Number) message to the TAS. In block 96, the TAS returns a MSRN (Mobile Station Roaming Number) or IMRN (IP Multimedia Routing Number), which enables the call to be routed to the IMS network where the UE is currently located. The Media Gateway Control Function (MGCF) of the IMS can route the invite message to the inbound roaming I/S-CSCF. The session then follows standard IMS procedures to set up the call. In blocks 98 and 100, iFC execution or Public Service Identity (PSI) routing routes the invite to the TAS, and the TAS provides terminating supplementary and IN services based on the user profile previously obtained from the HLR.

Accordingly, an IMS core network is configured to support inbound roaming subscribers of another network operator to derive additional revenue for provision of services. As described above, the Visiting Subscriber Server is configured to support standard 3GPP Cx interface with the I-CSCF and S-CSCF. The VSS is not required to be statically pre-provisioned with subscriber information for the inbound roaming visitors. The VSS is configured to dynamically create temporary subscriber records in response to inbound roaming subscribers accessing the IMS network. The VSS is also configured to retrieve authentication credentials such as AKA vectors from the HLR of the inbound roaming subscriber's home network for authentication. The VSS is further configured to dynamically derive and create IMS public and private identities for the inbound roaming subscriber based on the MSISDN and IMSI respectively. The VSS is further configured to provide default IMS profile for the inbound roaming subscriber for use during IMS registration.

The VSS may be a functionality residing in a network node such as the HSS, or it may be an independent network node. The VSS may comprise a server including microprocessor(s), memory, and input and output ports.

The features of the present invention which are believed to be novel are set forth below with particularity in the appended claims. However, modifications, variations, and changes to the exemplary embodiments described above will be apparent to those skilled in the art, and the system and method described herein thus encompasses such modifications, variations, and changes and are not limited to the specific embodiments described herein.

What is claimed is:

1. A method for supporting an inbound roaming subscriber in an IMS network, comprising:
receiving a request from the inbound roaming subscriber to access the IMS network;
determining the inbound roaming subscriber's home network;
retrieving authentication credentials from the inbound roaming subscriber's home network, and verifying the authentication credentials;
dynamically deriving public and private user identities for the inbound roaming subscriber; and
creating and storing a subscriber record for the inbound roaming subscriber.

2. The method of claim 1, wherein retrieving authentication credentials comprises retrieving AKA authentication vectors from a Home Location Register (HLR) in the inbound roaming subscriber's home network.

3. The method of claim 1, wherein creating and storing a subscriber record comprises creating and storing a temporary subscriber record.

4. The method of claim 1, wherein creating and storing a subscriber record comprises creating and storing a persistent subscriber record.

5. The method of claim 1, wherein dynamically deriving public and private user identities for the inbound roaming subscriber comprises dynamically deriving the public and private user identities from MSISDN and IMSI of the inbound roaming subscriber.

6. The method of claim 1, further comprising generating a user profile for the inbound roaming subscriber.

7. The method of claim 6, wherein generating the user profile comprises downloading an IMS profile including locally-configured iFCs.

8. The method of claim 1, further comprising communicating with the HLR via a MAP interface.

9. The method of claim 1, further comprising communicating with a Call Session Control Function via a Cx interface.

10. The method of claim 1, further comprising routing the request to an inbound roaming Call Session Control Function.

11. A system supporting an inbound roaming subscriber in an IMS network, comprising:
a Cx interface to a Call Session Control Function;
a MAP interface to a Home Location Register; and
a computer configured to:
receive a request from the inbound roaming subscriber to access the IMS network;
determine the inbound roaming subscriber's home network;
retrieve authentication credentials from the inbound roaming subscriber's home network, and verifying the authentication credentials;
dynamically derive public and private user identities for the inbound roaming subscriber; and
create and store a subscriber record for the inbound roaming subscriber.

12. The system of claim 11, wherein the computer is further configured to retrieve AKA authentication vectors from a Home Location Register (HLR) in the inbound roaming subscriber's home network.

13. The system of claim 11, wherein the computer is further configured to create and store a temporary subscriber record.

14. The system of claim 11, wherein the computer is further configured to create and store a persistent subscriber record.

15. The system of claim 11, wherein the computer is further configured to dynamically derive the public and private user identities from MSISDN and IMSI of the inbound roaming subscriber.

16. The system of claim 11, wherein the computer is further configured to generate a user profile for the inbound roaming subscriber.

17. The system of claim 11, wherein the computer is further configured to route the request to an inbound roaming Call Session Control Function.

18. A method for supporting an inbound roaming subscriber in an IMS network, comprising:
receiving a request from the inbound roaming subscriber to access the IMS network at an inbound roaming Call Session Control Function;
determining the inbound roaming subscriber's home network;
retrieving authentication credentials from the inbound roaming subscriber's home network, and verifying the authentication credentials;
dynamically deriving public and private user identities for the inbound roaming subscriber; and
creating and storing a temporary subscriber record for the inbound roaming subscriber.
